(19) United States
(12) Patent Application Publication
(10) Pub. No.: US 2014/0036966 A1
(43) Pub. Date: Feb. 6, 2014

(54) VARYING RATE OF DELETABLE BITS FOR SPREAD SPECTRUM CLOCKING

(71) Applicant: Robert C. Elliott, Houston, TX (US)

(72) Inventor: Robert C. Elliott, Houston, TX (US)

(21) Appl. No.: 13/563,036

(22) Filed: Jul. 31, 2012

(51) Int. Cl. H04B 1/707

(52) U.S. Cl. 375/145; 375/E01.002

(57) ABSTRACT

Varying insertion rates of deletable characters that are discarded by a receiver, as a function of transmission rate in spread spectrum clocking systems. Such systems can generate a spread spectrum modulation, based on their knowledge about the rate of transmission. The systems can dynamically adjust the rate/numbers of deletable characters that are inserted in the transmission. Accordingly, the insertion rate can increase (or decrease) when the transmission rate exceeds above (or falls below) a predetermined threshold.

### BACKGROUND

High speed serial communications are widely employed between digital units, and spread spectrum clocking represents a technology that reduces radiated emissions for such units. In spread spectrum clocking, the clock frequency can be modulated to reduce the signal power associated with the clock and the clock based signals, via spreading number of frequencies where power exists at any given period of time.

### BRIEF DESCRIPTION OF THE DRAWINGS

FIG. 1 illustrates an example of a block diagram for a system that varies insertion of deletable characters, according to an implementation of the subject disclosure.

FIG. 2 illustrates an implementation for a transmitter according to another aspect of the subject disclosure.

FIG. 3 illustrates another example for a block diagram with an adjustable rate component, according to a further aspect of the subject disclosure.

FIG. 4 illustrates an example of a methodology for varying a rate of deletable characters as a function of transmission rates.

FIG. 5 illustrates an example for a system that implements an artificial intelligence that varies rate of insertion of deletable characters, according to another implementation.

FIG. 6 illustrates a further methodology of inserting deletable characters that varies based on rate of transmission, in accordance with an aspect of the subject disclosure.

FIG. 7 illustrates an example for a network environment that can implement various aspects of the subject disclosure.

### DETAILED DESCRIPTION

High-speed serial transmitters and receivers do not operate and run at precisely the same frequency, and their frequency variations can lie in a predetermined range range such as ±100 part per million (ppm) and ±350 ppm, for example. To this end, a high-speed serial transmitter that is running faster than its corresponding receiver, may insert deletable bits that are subsequently discarded at the receiver end to avoid buffer overflows.

The rate of inserting such deletable bits can be a function of the frequency difference, which can be permitted or tolerated for a data transmission between a high speed serial transmitter and its corresponding receiver. Accordingly, these deletable bits can be employed in various high-speed serial interfaces, such as PCI Express (SKP ordered sets); Serial Attached SCSI (deletable primitives such as ALIGN and NOTIFY primitives); Serial ATA (ALIGN primitive).

In this regard when spread-spectrum clocking (SSC) is employed, the frequency difference can increase and become much wider (e.g., +0 ppm to −5000 ppm is added on top of the base +/−250 ppm, resulting in a full range of +250 ppm/−5250 ppm). This wide range can require a substantially larger rate of deletable bits, wherein SSC can change the amount of high-speed frequency variation at a slowly changing rate, (e.g. a triangle wave at 30 kHz.)

In a related example, Serial Attached SCSI (SAS) may require 1 out of every 128 DWORD be a deletable primitive, to accommodate for the +2400/−5350 ppm worst case frequency variation, when communicating the SAS controller—wherein such deletable bits can cause overhead and reduce associated bandwidth Likewise, other interfaces can encounter different SSC range requirements and corresponding overhead burdens.

Various implementations of the subject disclosure provide for transmitters that can vary their rate/amount of deletable characters (which are required to be placed in their/protocols transmission) as a function of a rate of transmission. Because such transmitters generate a spread spectrum modulation themselves, they have knowledge about their rate of transmission. Based on such knowledge about rate of transmission, they can dynamically adjust the rate/numbers of deletable characters placed in the transmission. For example, when such transmitter becomes aware that it is transmitting at a high rate (e.g., over a predetermined threshold) it can then increase the number of deletable characters. On the other hand, if such transmitter recognizes that the rate of such transmission is slow (e.g., below a predetermined threshold), it can then reduce the number of deletable characters.

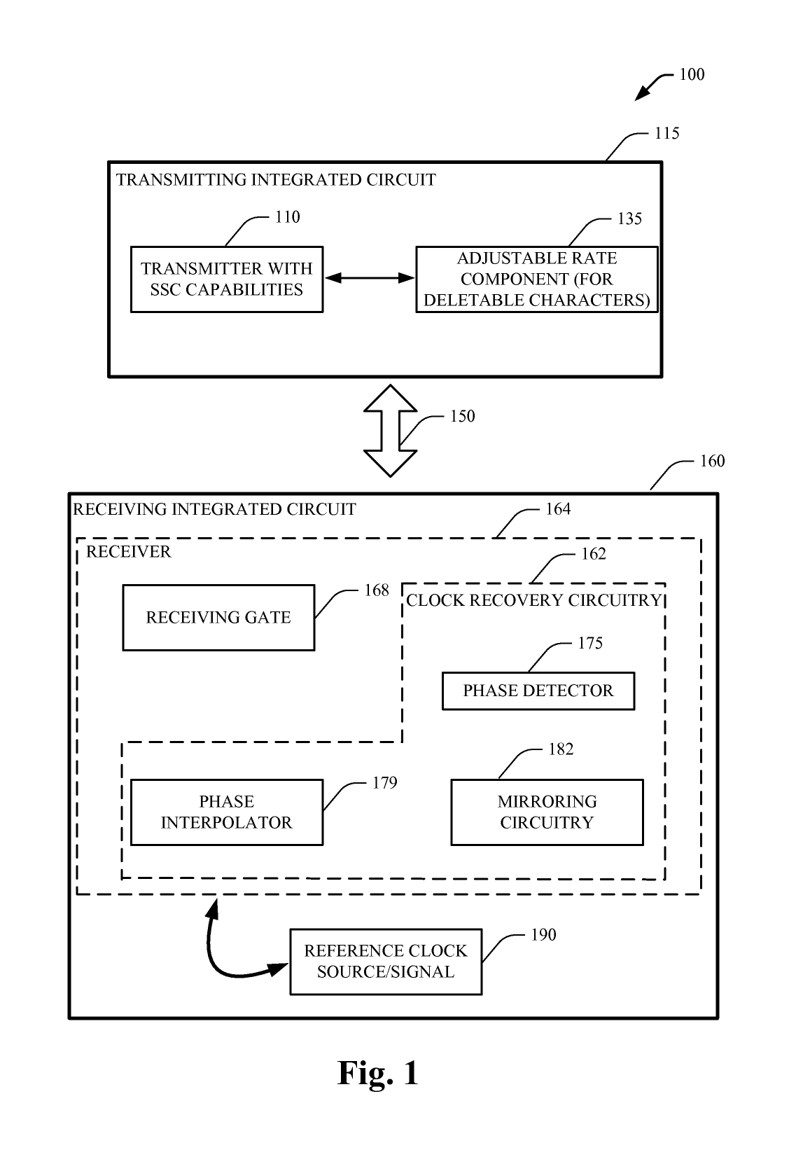

FIG. 1 illustrates an example of a system 100 that can vary a rate/amount of deletable characters, which are inserted in associated transmissions—by employing an adjustable rate component 135. The system 100 includes a transmitting integrated circuit 115 that communicates data with a receiving integrated circuit 125, wherein the transmitter 110 includes SSC capabilities, which can vary a rate/amount of deletable characters that are inserted in associated protocols and/or transmissions. In one implementation, the SSC can represent a scheme in which the frequency of a clock signal changes in a triangular waveform between a maximum frequency (fmax) and a minimum frequency (fmin) that is equal to 0.995 fmax. The frequency of triangular waveform can be about 30 kHz—wherein the fmax can be many times greater (e.g., 100 MHz or higher). The adjustable rate component 135 can vary the rate that deletable characters are insertable into the communication data stream.

As illustrated in FIG. 1, the interconnect 150 can be employed to transmit a data signal with embedded clock information to the receiving integrated circuit 160. The clock information may be embedded through various coding techniques, wherein the transmitter 110 is part of the transmitting integrated circuit 115, which transmits the data signal in response to an SSC transmitting clock signal.

Moreover, the data signal may have a phase change or other change that tracks the frequency change in the SSC transmitting clock signal. The transmitter 110 and the interconnect 150, and a receiver 164 in the receiving integrated circuit 160 may form a point to point serial link, wherein the interconnect 150 may be unidirectional or bidirectional.

In addition, receiver 164 can include a receiving gate 168 and a clock recovery circuitry 162; wherein the clock recovery circuitry 162 further includes a phase detector 175, a phase interpolator 179, and mirroring circuitry 182, which can create a frequency mirrored clock signal.

In one implementation, the receiver 164 can be an interpolator based receiver, and the phase detector 175 can analyze the data signal on interconnect 150, to extract phase information regarding the data signal. Furthermore, the phase detector 175 can employ edge detection, wherein the phase information can be included in a phase information signal provided to phase interpolator 179. As illustrated in FIG. 1, a local reference source 190 can produce a reference clock signal which has a frequency that is substantially close to, the maximum or minimum frequency of the SSC transmitting clock signal provided to transmitter 110. Such local reference source 190 may be internal or external to receiving integrated circuit 160.

The transmitter 110 can generate a spread spectrum modulation, and therefore has knowledge about rate of transmission. Accordingly and based on such knowledge about rate of transmission, the adjustable rate component 135 can dynamically adjust the rate/numbers of deletable characters placed in the transmission over the interconnect 150. In this regard, when the transmitter 110 becomes aware that it is transmitting at a high rate (e.g., over a predetermined threshold), it can then increase the number of deletable characters. Alternatively, if the transmitter 110 recognizes that the rate of such transmission is slow (e.g., below a predetermined threshold), it can then reduce the number of deletable characters.

In a related implementation, the phase interpolator 179 can create the in phase clock signal, via employing the frequency mirrored clock signal and the phase information signal. In this regard, the receiving gate 168 can receive the data signal on interconnect 150 and the in phase clock signal from phase interpolator 179.

The adjustable rate component 135 can mitigate (or eliminate) unnecessary bandwidth loss while still supporting a wide range of SSC. For example, in PCI Express Gen3 (8 GT/s), designs supporting a 100 MHz common clock may be required to tolerate +300/−300 ppm. Designs not supporting that clock are exposed to +300/−5300 ppm, requiring a substantially higher deletable bit rate.

While the transmitter may be substantially near −5300 ppm, it need not send as many deletable bits as while it is near +300 ppm, since the receiver 164 will not be slower than −5300 ppm. In such implementation, the adjustable rate component 135 can halve the bandwidth impact, as the transmitter 110 sends deletable bits at the full specified rate when fast; but none at all when slow. Such can further facilitate full compliance with the increased rate as required by SSC, wherein rate required even without SSC is still provided.

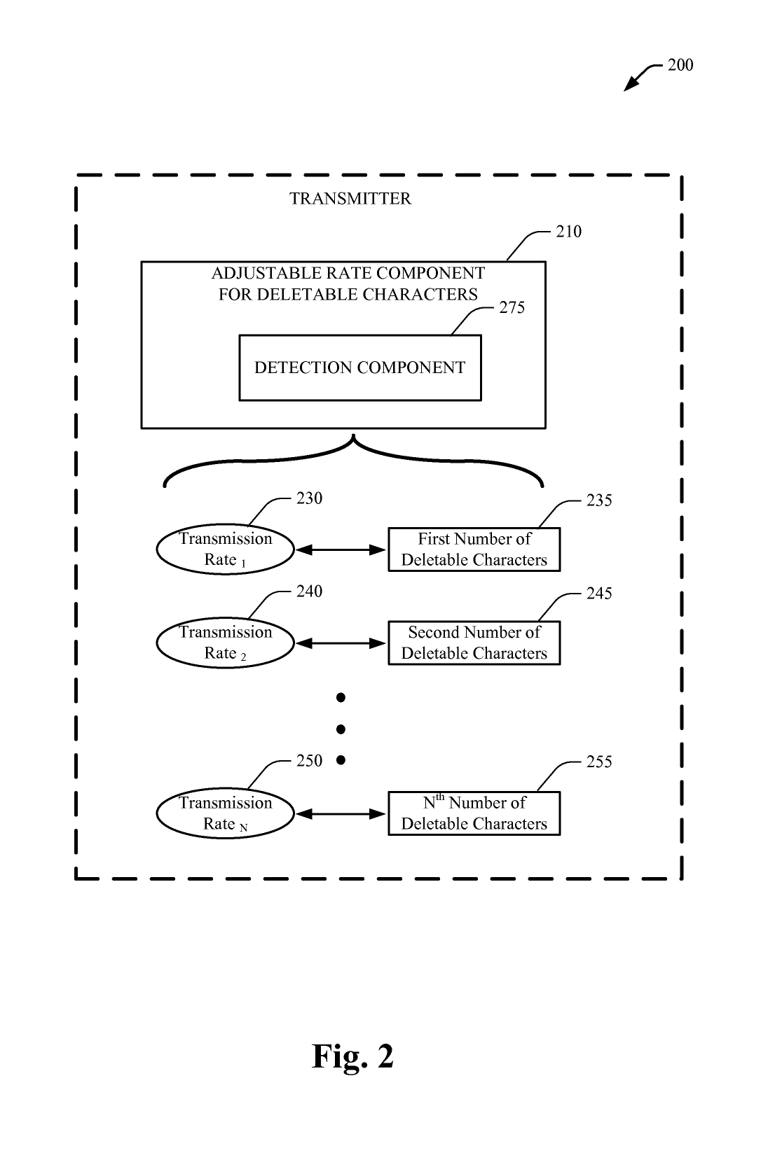

FIG. 2 illustrates an example of a transmitter 200 according to an implementation of the subject disclosure. The transmitter 200 can employ a plurality of transmission rates 230, 240, 250 (1 to N, where N is an integer)—wherein each of transmission rates 230, 240, 250 can correspond to a respective number of deletable characters 235, 245, 255. The deletable characters can represent bits that are discarded by a receiver to avoid buffer overflows.

As illustrated in FIG. 2, the rate of inserting deletable bits can be a function of the rate of transmission by the transmitter—which itself can depend on permitted frequency difference between the transmitter and receiver, for example.

In a related implementation, the detection component 275 can detect a rate of transmission 230, 240, 250 generated based on a spread spectrum modulation. Based on such detection and knowledge about rate of transmission, the transmitter can dynamically (e.g., on-the-fly) adjust the rate/numbers of deletable characters placed in the transmission.

Accordingly, by varying a rate and/or amount of deletable characters that are insertable in protocols/transmissions, as a function of a rate of transmission itself- overhead and inefficiencies can be mitigated.

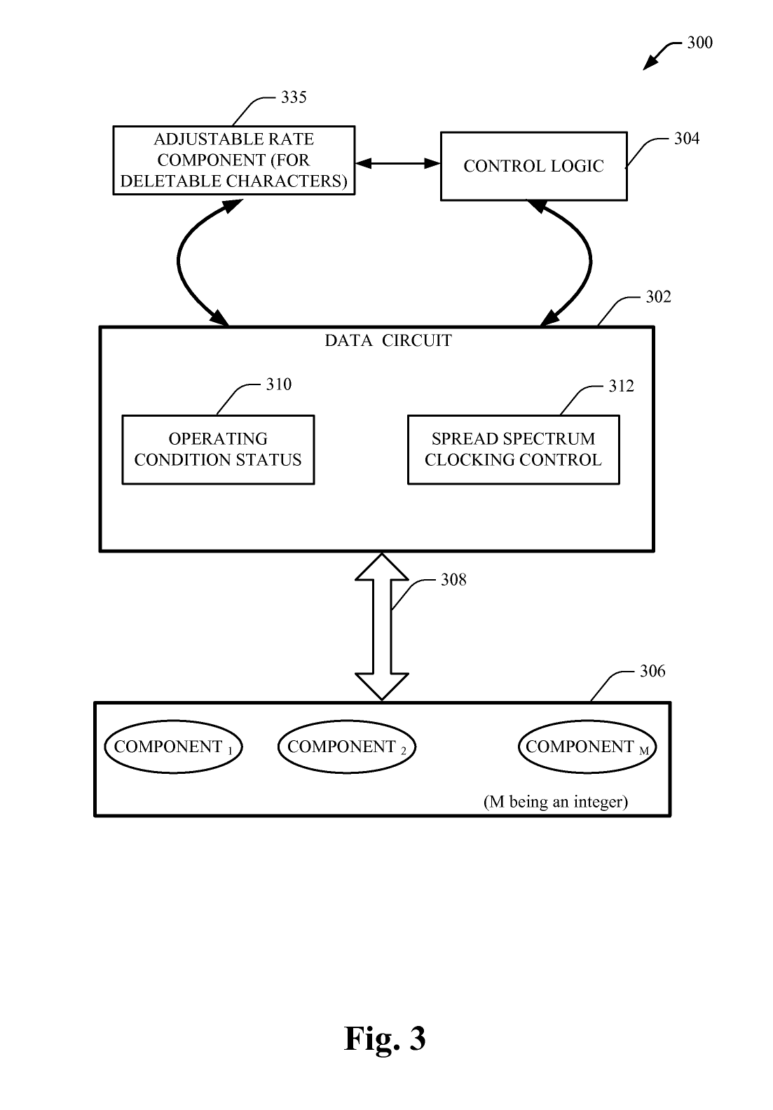

FIG. 3 illustrates an example for a data transfer circuit 300, wherein SSC for data transfer bus loading can be implemented in conjunction with an adjustable rate component 335. Based on intelligence about rate of transmission, the adjustable rate component 335 can dynamically adjust the rate/numbers of deletable characters placed in the transmission over the data transfer bus 308.

The data transfer circuit 300 includes a data circuit 302, control logic 304, one or more system components 306, and the data transfer bus 308 over which data circuit 302 communicates data with the one or more system components 306. The data transfer bus 308 can include any one or more of a data bus, an address bus, a control bus, a memory bus, and the like.

Moreover, the data circuit 302 can include an operating condition(s) status 310 and an SSC control 312. In this regard, the operating condition(s) status can indicate operating condition(s) of the data circuit 302, and can further correspond to data communications loading on the data transfer bus 308. The operating conditions can further include any one of process, voltage, and/or temperature conditions of the data circuit 302.

The SSC control 312 can control a frequency spread deviation for data communication via data transfer bus 308. The SSC control 312 can be implemented as a phase-locked loop, for example, that dithers the frequency signal of a data communication. Moreover, the frequency spread deviation of data communications can be controlled by adjusting a minimum clock frequency and a maximum clock frequency, or by adjusting a percentage clock frequency deviation from a center frequency. Likewise, the minimum clock frequency and the maximum clock frequency define a dithering range to spread out the energy of the communicated data. By detecting and awareness about rate of transmission, the adjustable rate component 335 can dynamically adjust the rate/numbers of deletable characters placed in the transmission for the system 300.

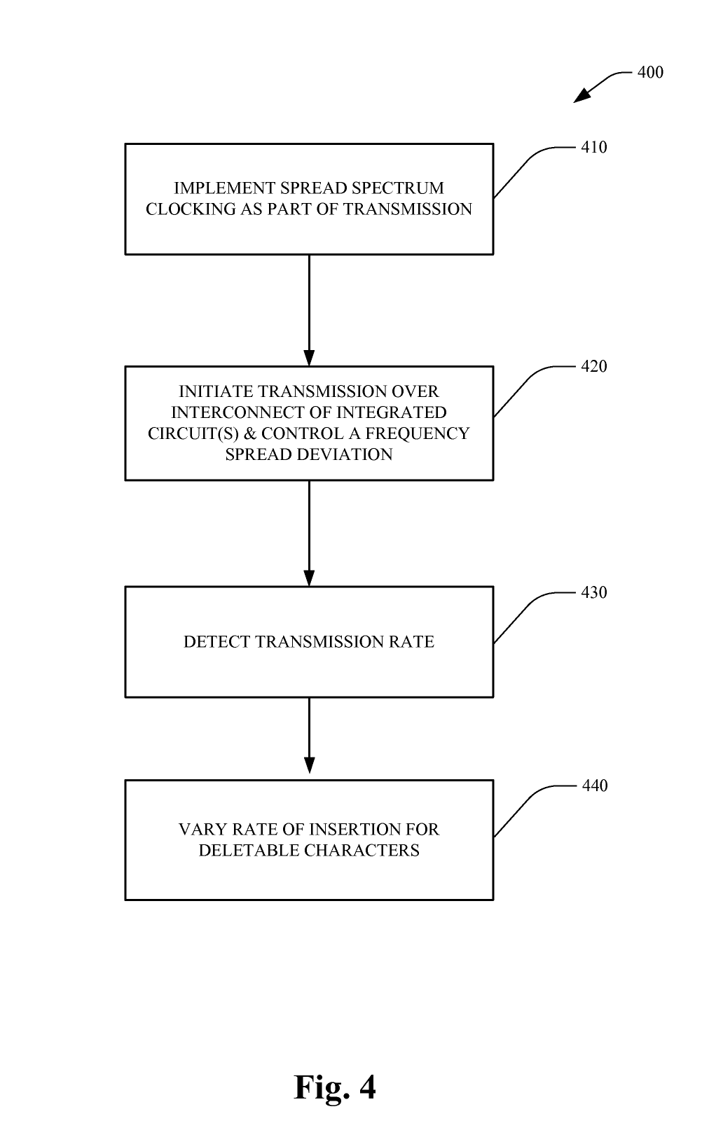

FIG. 4 illustrates a related methodology of varying the rate and/or amount of deletable characters as a function of rate of transmission rate. Initially and at 410 SSC can be implemented as part of transmitter capabilities related to communications in an integrated circuit(s). At 420, transmission can be initiated between a transmitter and a receiver via an interconnect of the integrated circuit(s), wherein data signal are transmitted in response to an SSC transmitting signal, wherein a frequency spread deviation can be controlled by adjusting the minimum clock frequency and/or maximum clock frequency. The transmission rate can correspond to a respective number of deletable characters representing bits that can be discarded by a receiver to avoid buffer overflows.

The rate of transmission generated based on a spread spectrum modulation can then be detected at 430. Based on such detection and knowledge about rate of transmission with SSC, the rate of insertion for deletable characters can be varied (e.g., on-the-fly and/or in real time) at 430 (e.g., the insertion rate is at a higher rate when the transmission is faster, and the insertion rate is slower when the transmission is slower.) Hence, unnecessary bandwidth loss and overhead inefficiencies can be mitigated.

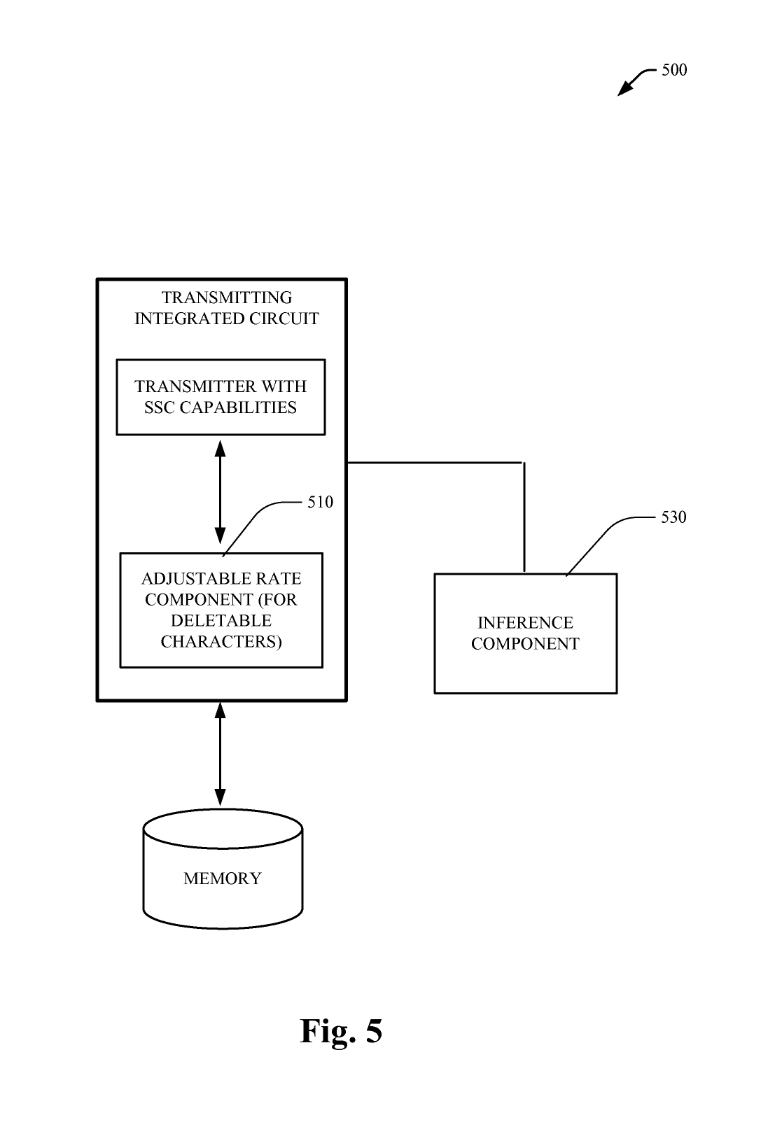

FIG. 5 illustrates a system 500 having an inference component 530 (e.g., an artificial intelligence—AI) that can interact with the adjustable rate component 510, to facilitate inferring and/or determining when, where, how to insert deletable characters by a transmitter with SSC capabilities, according to an aspect of the subject disclosure.

As used herein, the term “inference” refers generally to the process of reasoning about or inferring states of the system, environment, and/or user from a set of observations as captured via events and/or data. Inference can identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The inference component 530 can employ any of a variety of suitable AI-based schemes as described supra in connection with facilitating various aspects of the herein described subject matter. For example, a process for learning explicitly or implicitly how parameters are to be created for training models based on similarity evaluations can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

The subject application can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, SVM's can be configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

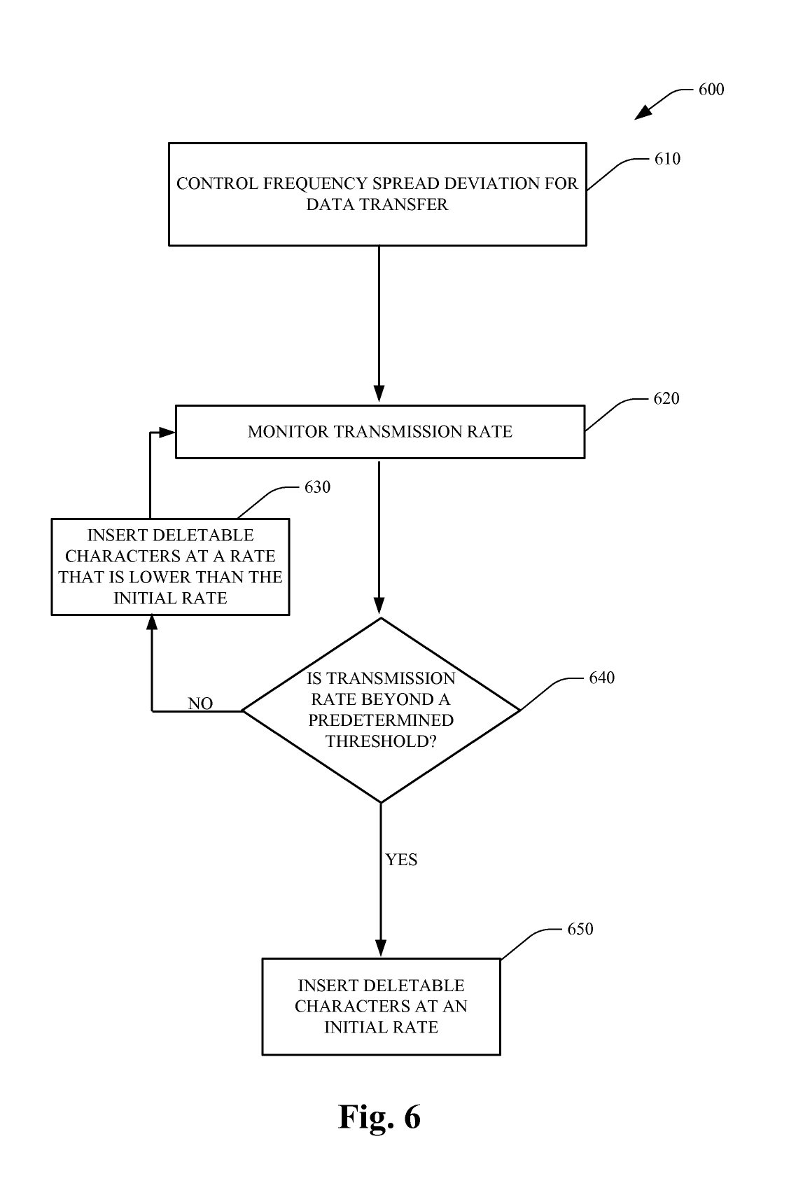

FIG. 6 illustrates a further methodology 600 of inserting deletable characters that can vary based on rate of transmission, in accordance with an aspect of the subject disclosure. At 610 a SSC can be implemented as part of a data transfer bus loading in an integrated circuit. In such transmission, the rate of inserting such deletable bits can be a function of the transmission rate and/or frequency difference, which can be permitted or tolerated for a data transmission between a high speed serial transmitter and its corresponding receiver. At 620, the rate of transmission can be monitored wherein based on such monitoring and knowledge about rate of transmission, the transmitter can dynamically adjust the rate/numbers of deletable characters placed in the transmission—wherein the deletable bits can be associated with various high-speed serial interfaces, such as PCI Express (SKP ordered sets); Serial Attached SCSI (Deletable primitives such as ALIGN and NOTIFY primitives); Serial ATA: (ALIGN primitive). At 640 a determination can be made that the rate of transmission is beyond a predetermined threshold, wherein the predetermined threshold can be a function of frequency differences between the integrated circuit of the transmitter and that of the receiver. If so, the methodology can proceed to 650 wherein deletable characters can be inserted at an initial rate; and if not the methodology proceeds to 630, wherein deletable characters are inserted at a rate that is lower than the initial rate.

To this end, when signal spread-spectrum clocking (SSC) is employed, the frequency difference can increase and become much wider (e.g., +0 ppm to −5000 ppm is added on top of the base +/−250 ppm, resulting in a full range of +250 ppm/−5250 ppm). This wide range can require a substantially larger rate of deletable bits, wherein SSC can change the amount of high-speed frequency variation at a slowly changing rate, e.g. a triangle wave at 30 kHz.

In a related example, SAS may require 1 out of every 128 registry DWORD be deletable primitive, to accommodate the +2400/−5350 ppm worst case frequency variation when communicating SAS controller, wherein such deletable bits can cause overhead and reduce associated bandwidth Likewise, other interfaces can encounter different SSC range requirements and corresponding overhead burdens.

### EXEMPLARY NETWORKED AND DISTRIBUTED ENVIRONMENTS

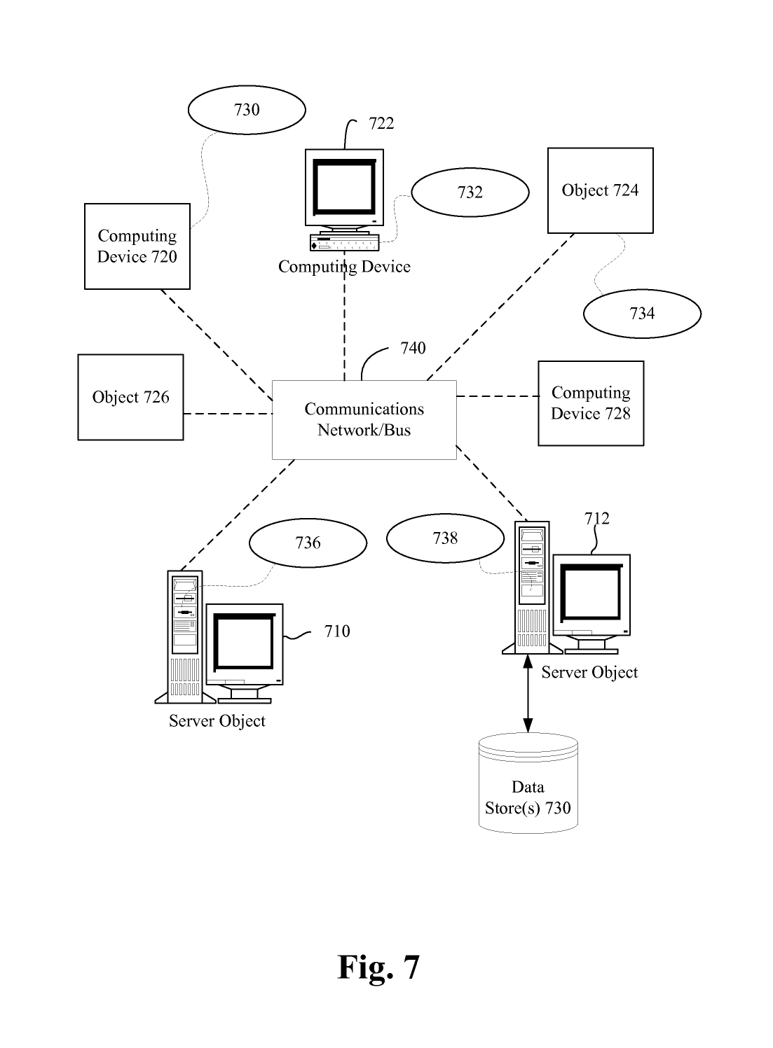

FIG. 7 provides a schematic diagram of an exemplary networked or distributed computing environment in which examples described herein can be implemented. The distributed computing environment includes computing objects 710, 712, etc. and computing objects or devices 720, 722, 724, 726, 928, etc., which can include programs, methods, data stores, programmable logic, etc., as represented by applications 730, 732, 734, 736, 738. It is to be appreciated that computing objects 710, 712, etc. and computing objects or devices 720, 722, 724, 726, 728, etc. can include different devices, such as personal digital assistants (PDAs), audio/video devices, mobile phones, MPEG-1 Audio Layer 3 (MP3) players, personal computers, laptops, tablets, and the like.

Each computing object 710, 712, etc. and computing objects or devices 720, 722, 724, 726, 728, etc. can communicate with one or more other computing objects 710, 712, etc. and computing objects or devices 720, 722, 724, 726, 728, etc. by way of the communications network 740, either directly or indirectly. Even though illustrated as a single element in FIG. 7, communications network 740 can include other computing objects and computing devices that provide services to the system of FIG. 7, and/or can represent multiple interconnected networks, which are not shown. Each computing object 710, 712, etc. or computing objects or devices 720, 722, 724, 726, 728, etc. can also contain an application, such as applications 730, 732, 734, 736, 738, that might make use of an application programming interface (API), or other object, software, firmware and/or hardware, suitable for communication with or implementation of the various examples of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various examples.

Thus a host of network topologies and network infrastructures, such as client/server, peer-to-peer, or hybrid architectures, can be utilized. The client can be a member of a class or group that uses the services of another class or group. A client can be a computer process, e.g., roughly a set of instructions or tasks, that requests a service provided by another program or process. A client can utilize the requested service without having to know all working details about the other program or the service itself. used in this application, the terms “component,” “module,” “system,” and the like are intended to refer to a computer-related entity, either hardware, software, firmware, a combination of hardware and software, software and/or software in execution. For example, a component can be, but is not limited to being, a process running on a processor, a processor, an object, an executable, a thread of execution, a program, and/or a computer. By way of illustration, both an application running on a computing device and/or the computing device can be a component. One or more components can reside within a process and/or thread of execution and a component can be localized on one computer and/or distributed between two or more computers. In addition, these components can execute from various computer-readable storage media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal). In one example, the techniques of the present application can be employed using a memory that stores computer-executable or computer-readable instructions and a processor or computer communicatively coupled to the processor or computer that facilitates execution of the computer-executable or computer- readable instructions to perform functionality of the present application.

In a client server architecture, particularly a networked system, a client can be a computer that accesses shared network resources provided by another computer, e.g., a server. In the illustration of FIG. 7, as a non-limiting example, computing objects or devices 720, 722, 724, 726, 728, etc. can be thought of as clients and computing objects 710, 712, etc. can be thought of as servers where computing objects 710, 712, etc. provide data services, such as receiving data from client computing objects or devices 720, 722, 724, 726, 728, etc., storing of data, processing of data, transmitting data to client computing objects or devices 720, 722, 724, 726, 728, etc., although any computer can be considered a client, a server, or both, depending on the circumstances. Any of these computing devices can process data, or request transaction services or tasks that can implicate the techniques for systems as described herein for one or more examples

A server can be typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network/bus 740 can be the Internet, for example, the computing objects 710, 712, etc. can be Web servers, file servers, media servers, etc. with which the client computing objects or devices 720, 722, 724, 726, 728, etc. communicate via any of a number of known protocols, such as the hypertext transfer protocol (HTTP). Computing objects 710, 712, etc. can also serve as client computing objects or devices 720, 722, 724, 726, 728, etc., as can be characteristic of a distributed computing environment. In addition to the various aspects described herein, it is to be understood that other similar examples can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be affected across a plurality of devices.

What is claimed is:

1. A system comprising:
a circuit that controls a spread spectrum clocking (SSC) for a data communication between a transmitter and a receiver; and
a rate adjustment component that varies a rate of deletable characters inserted by the transmitter and discarded by the receiver during the data communication.

2. The system of claim 1 further comprising a detection component that detects a rate of transmission by the transmitter.

3. The system of claim 1 further comprising a phase detector that extracts a phase information signal from a signal associated with the data communication.

4. The system of claim 1, wherein the rate of deletable characters increases when a rate of transmission exceeds a predetermined threshold.

5. The system of claim 1, wherein the rate of deletable characters decreases when the rate of transmission falls beneath the predetermined threshold.

6. The system of claim 1, wherein the system is associated with an SAS, or a PCI Express, or a Serial ATA, or a USB, or an Ethernet.

7. The system of claim 1 further comprising an interconnect that employs a serial attached protocol for the data communication.

8. The system of claim 1 wherein the SSC for the circuit is implemented as a phase-locked loop.

9. A computer system comprising:
a memory that stores computer-executable instructions; and
a processor communicatively coupled to the processor that facilitates execution of the computer-executable instructions to at least:
control a frequency spread deviation for data communication between a transmitter and a receiver; and
vary a rate of inserting deletable characters that are discarded by the receiver, based on a transmission rate from the transmitter to the receiver.

10. A method of transmitting data comprising;
supplying a spread spectrum clocking for a transmission of data between a transmitter and a receiver;
inserting deletable characters by the transmitter as part of the transmission, the deletable characters discarded by the receiver; and
varying a rate for insertion of the deletable characters, based on a transmission rate from the transmitter to the receiver.

11. The method of claim 10 further comprising monitoring the transmission rate.

12. The method of claim 10 further comprising varying the rate of insertion in real-time.

13. The method of claim 10 further comprising detecting the rate of transmission.

14. The method of claim 10 further comprising supplying a phase information signal.

15. The method of claim 10 further comprising mirroring frequency changes in data signals.
